(19) United States
(12) Patent Application Publication
(10) Pub. No.: US 2004/0130100 A1
(43) Pub. Date: Jul. 8, 2004

(54) Seal for rotating interface

(75) Inventors: Jeffrey Allen Oram, Vancouver, WA (US); Patrick Lee Dolan, Washougal, WA (US)

Correspondence Address: Kolisch Hartwell, P.C., 200 Pacific Building, 520 S.W. Yamhill Street, Portland, OR, 97204, US

(73) Assignee: Oramac, Inc.

(21) Appl. No.: 10/338,205

(22) Filed: Jan. 7, 2003

(51) Int. Cl. F16J 15/34

(52) U.S. Cl. 277/358

(57) ABSTRACT

A sealing assembly provides for rotatably coupling a rotary drum and a pipe at a trunnion on the drum that has a generally circular opening configured to rotate about the pipe. The sealing assembly includes a housing with a chamber configured to contain a pressurizable fluid. The housing is configured to be coupled to adjustment screws extending through a mounting plate on the pipe. The sealing assembly also includes a seal with a bearing surface coupled to a driven portion. The bearing surface generally defines a circular shape corresponding to the trunnion opening. The seal is coupled to the housing with the driven portion of the seal responsive to fluid pressure in the housing chamber. The seal is configured to be biased by the fluid, when pressurized, against the trunnion opening. The bearing surface is disposed at an oblique angle with respect to the plane of the trunnion opening. The trunnion includes an outer annular surface that is substantially in the plane defined by the trunnion opening, and the outer annular surface adjoins at a corner an inner cylindrical surface of the trunnion. The bearing surface of the seal substantially contacts only the corner of the trunnion opening.

### BACKGROUND

Pulp is processed in part by drawing the pulp out of a slurry in a vat using a rotary vacuum filter that includes a rotary drum. The vacuum filter pulls the pulp onto a mesh screen that forms a major part of the cylindrical structure of the rotary drum. The liquid in the slurry is pulled into the interior of the rotary drum and flows out a discharge valve located at one end of the drum and down a discharge pipe. The rotary drum typically includes a trunnion adjacent the discharge valve, and the trunnion rotates with the drum while the discharge pipe remains stationary. The liquid within the drum is under vacuum and it is necessary to prevent the vacuum from leaking at the interface between the trunnion and the discharge pipe.

Prior art seals at the interface between the trunnion and the discharge pipe have included packing material stuffed in a channel between the trunnion and the pipe. The channel is formed because the trunnion has a larger inner diameter than the outer diameter of the discharge pipe and the pipe is positioned to extend into the trunnion. The packing materials used in the channel have tended to abrade the trunnion over time, and replacing the trunnion is very expensive. U.S. Pat. No. 4,795,572 describes a sealing means that is coupled to bolts on the discharge pipe by spring means extending from each bolt. The sealing means includes a flat surface that mates with a flat annular surface on the trunnion. A problem observed in the field for this type of sealing means is that the bolts, which are manually adjusted, create uneven pressure between the sealing means and the trunnion. The result is excessive wear on the sealing means and the trunnion, poor sealing, and lost vacuum.

### SUMMARY OF THE INVENTION

A sealing assembly provides for rotatably coupling a trunnion of a rotary drum and a pipe. The sealing assembly includes a housing with a chamber configured to contain a pressurizable fluid. The housing is configured to be coupled to adjustment screws located on a mounting plate on the pipe. The sealing assembly further includes a seal with a bearing surface and a driven portion. The bearing surface generally defines a circular shape corresponding to a circular opening in the trunnion. The seal is coupled to the housing with the driven portion of the seal responsive to fluid pressure in the housing chamber. The seal is configured to be biased by the fluid, when pressurized, against the trunnion opening. The bearing surface is disposed at an oblique angle with respect to the plane of the trunnion opening.

The sealing assembly is for use with the trunnion wherein the trunnion includes an outer annular surface that is substantially in the plane defined by the trunnion opening, and the outer annular surface adjoins an inner cylindrical surface of the trunnion, forming a corner therebetween. The bearing surface of the seal substantially contacts only the corner of the trunnion opening. The seal and the housing are formed in two substantially semicircular halves and each is configured to be joined together around the pipe. The seal is provided by the pressurized fluid with a substantially uniformly distributed pressure about the substantially annular shape of the seal to bias the bearing surface against the trunnion opening.

### BRIEF DESCRIPTION OF THE DRAWINGS

FIG. 1 is a partially exploded, isometric view of the present invention incorporated in a rotary vacuum filter, which includes a rotary drum, a trunnion with an opening for discharging liquid from within the drum, the sealing assembly of the present invention, a mounting plate and attachment screws, and a discharge pipe, to which the mounting plate is coupled.

FIG. 2 is a side, cross-sectional view of the sealing assembly of FIG. 1, illustrating a seal and a housing for the seal coupled to the mounting plate around the discharge pipe, the seal including a beveled bearing surface that the corner of the trunnion opening bears on.

FIG. 3 is a cross-sectional view of the seal and housing of the present invention, and the associated discharge pipe.

FIG. 4 is an isometric view of the seal and housing of the present invention, showing the two halves of each bolted together.

FIG. 5 is a cross-sectional view of an alternative embodiment of the seal of the present invention, including a piston in a chamber of the housing coupled to the seal.

FIG. 6 is a partially cutaway, close-up view of a bolt coupling together the two halves of the housing of the present invention.

FIG. 7 is a top plan view of the housing of the present invention.

FIG. 8 is a partially cutaway view of a bolt coupling together the two halves of the seal of the present invention.

FIG. 9 is a top plan view of the seal of the present invention.

### DETAILED DESCRIPTION OF THE PREFERRED EMBODIMENTS

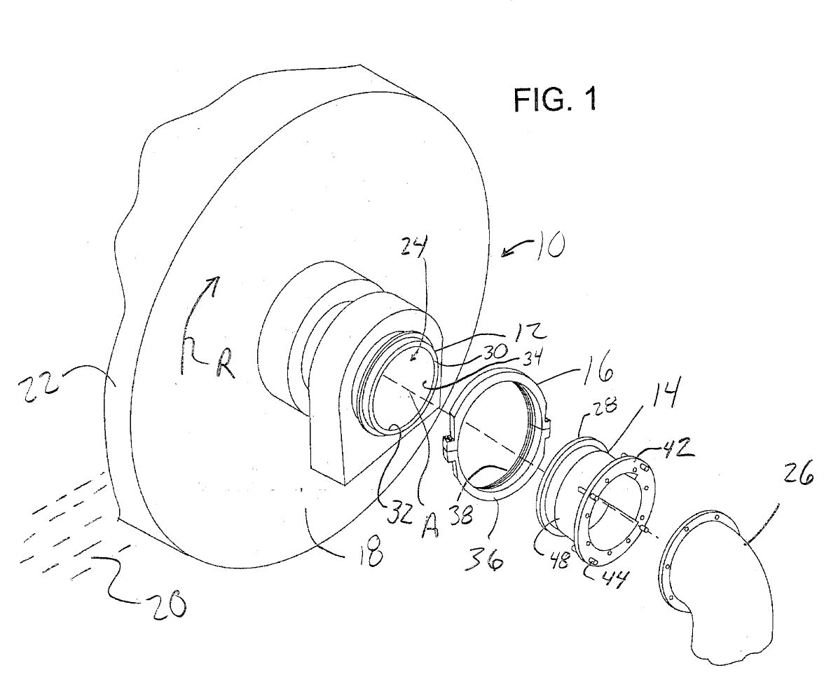

The present invention may be used in a rotary vacuum filter, such as that shown generally at 10 in FIG. 1, and in other applications involving a rotary interface between a trunnion 12 and a discharge pipe 14, or similar equipment. A sealing assembly 16 of the present invention provides for rotatably coupling a rotary drum 18 and pipe 14. Rotary drum 18 typically rotates about an axis A in a vat containing a slurry 20. As drum 18 rotates, a vacuum pulls liquid from slurry 20 through a mesh filter 22 into the interior of the drum. In a pulp processing application, the slurry contains pulp which adheres in a mat to the exterior of the drum and is drawn out of the slurry as the drum rotates about axis A as indicated by arrow R.

The liquid that passes through filter 22 must be evacuated out of the interior of drum 18, and the path for the liquid is out through a generally circular opening 24 in trunnion 12, through discharge pipe 14 and an elbow 26 to associated piping for further processing and/or recirculation of the liquid as required. Discharge pipe 14 is typically held stationary while trunnion 12 of rotary drum 18 rotates about discharge pipe 14. A related application for the present invention would be on the rotary drum on the end opposite the trunnion and discharge pipe, where there is a similar rotary interface, albeit without the pathway for the liquid discharge.

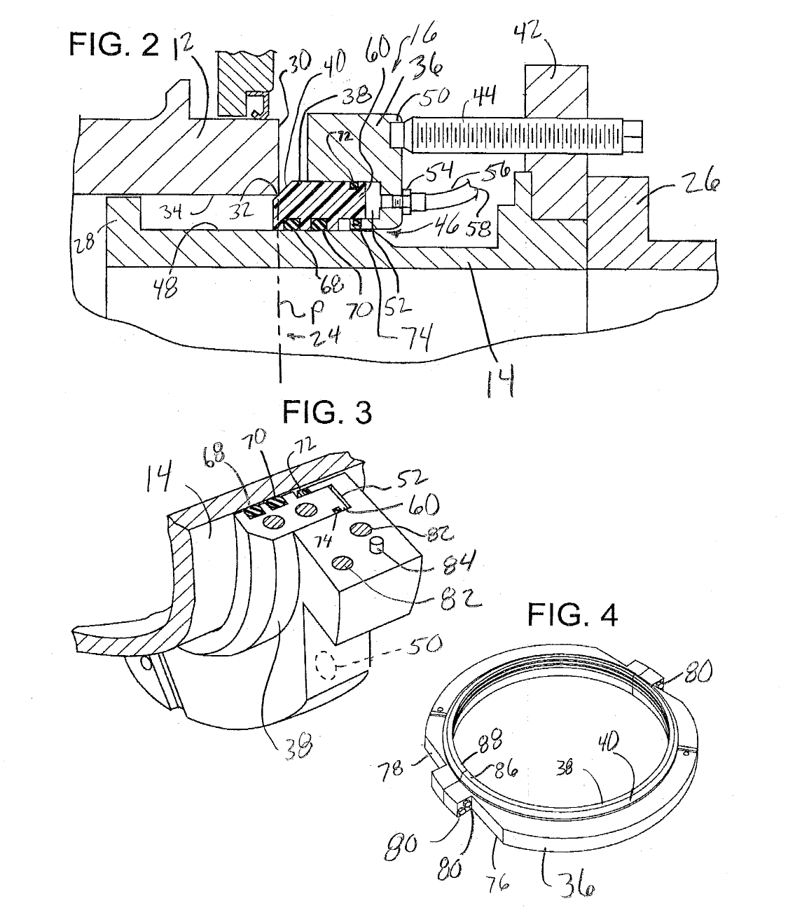

As best seen in FIG. 2, when the drum and the discharge pipe are coupled, trunnion 12 extends beyond a flanged end 28 of pipe 14 and trunnion 12 rotates about pipe 14. Trunnion opening 24 defines a plane P and trunnion 12 includes an outer annular surface 30 that is substantially in plane P. Outer annular surface 30 of trunnion 12 adjoins at a corner 32 an inner cylindrical surface 34 of the trunnion.

Sealing assembly 16 includes a housing 36 and a seal 38 for providing the rotating interface between the trunnion and the discharge pipe. Seal 38 includes a beveled bearing surface 40, configured to be at an oblique angle, i.e., greater than 0° and less than 90°, with respect to opening 24 and plane P, and preferably bearing surface 40 substantially contacts only corner 32 of trunnion opening 24. Preferably the angle of bearing surface 40 is about 45°, although other angles may be used.

Discharge pipe 14 includes a mounting plate 42 and typically six adjustment screws 44 coupled through the mounting plate. Housing 36 of sealing assembly 16 is configured to fit around pipe 14, preferably with a small clearance gap 46 between the housing and an outer cylindrical surface 48 of pipe 14. Housing 36 typically includes six apertures 50 for mounting the housing at screws 44. In the system of the present invention, adjustment screws 44 provide for gross positioning of the housing and seal adjacent trunnion opening 24, but fine adjustment of screws 44 does not affect the pressure of seal 38 against opening 24.

The pressing of seal 38 against trunnion opening 24 at corner 32 is provided by a chamber 52 in housing 36 which can be coupled through a fitting 54 to a source, such as hose 56, of a pressurizable fluid 58, such as air or water, or other suitable gas or liquid. A viscous liquid, such as an oil, may be used, although in the pulp processing application water is preferred to oil because the equipment is already typically wetted with water, and oil, if spilled, is a highly undesirable contaminant in pulp processing. Typically the desired pressure in chamber 52 for pressing seal 38 against trunnion corner 32 is between about 10 psi and about 20 psi although other pressure ranges may be appropriate for pulp processing or for other applications.

Seal 38 is shown in FIG. 2 in a pressurized condition where pressurized fluid in chamber 52 is operating on a driven portion 60 of seal 38 to move seal 38 outwardly and to press bearing surface 40 against trunnion corner 32. Typically the range of motion for seal 38 is on the order of about one-half inch, although this may be varied as conditions warrant. The seal is thus responsive to fluid pressure in the housing chamber and can be biased by the fluid, when pressurized, against the trunnion opening. The seal is shown in FIG. 3 with the chamber in an unpressurized condition wherein the seal is disposed further within the chamber as compared to the pressurized condition.

As best seen in FIGS. 4 and 9, seal 38 and bearing surface 40 generally define a circular shape that corresponds to the circular shape of the trunnion opening (see FIG. 1). In the field, trunnion openings typically are observed to exhibit a variation of no more than about ±0.040 inches and the seal can accommodate such variations, and the seal can be adjusted by material selection and by dimension tolerances to accommodate other magnitudes of variation in the circularity of the trunnion opening.

The seal preferably substantially comprises ultra high molecular weight polyethylene, although other suitable materials may be selected, such as polytetrafluoroethylene, as desired for the particular application.

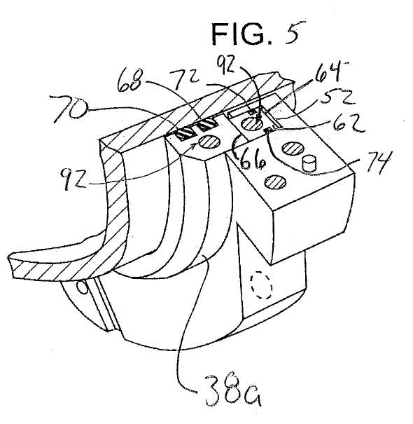

An alternative embodiment of the present invention is shown in FIG. 5 where a piston 62 is installed in chamber 52. Piston 62 includes an inner surface 64 which is driven by pressurized fluid, similar to the driven portion 60 of seal 38, and piston 62 includes an outer surface 66 which, in turn, drives a seal 38a, which otherwise is similar to seal 38.

Sealing assembly 16 preferably includes one or more o-rings to prevent leakage of the slurry liquid and of the pressurizable fluid. As shown in FIGS. 2, 3, and 5, a pair of o-rings 68, 70 each held in a groove in seal 38 provide for a watertight seal between seal 38 and pipe 14. Thus, the seal is in movable, sealing contact with outer cylindrical surface 48 of pipe 14.

A pair of o-rings 72, 74 prevent leakage of the pressurizable fluid from chamber 52. In the embodiment shown in FIGS. 2 and 3, o-rings 72, 74 are located in grooves in seal 38 and housing 36, respectively, while in the embodiment of FIG. 5, o-rings 72, 74 are located in piston 62. The o-rings may be placed in either of the seal/piston or the housing as desired for a particular application.

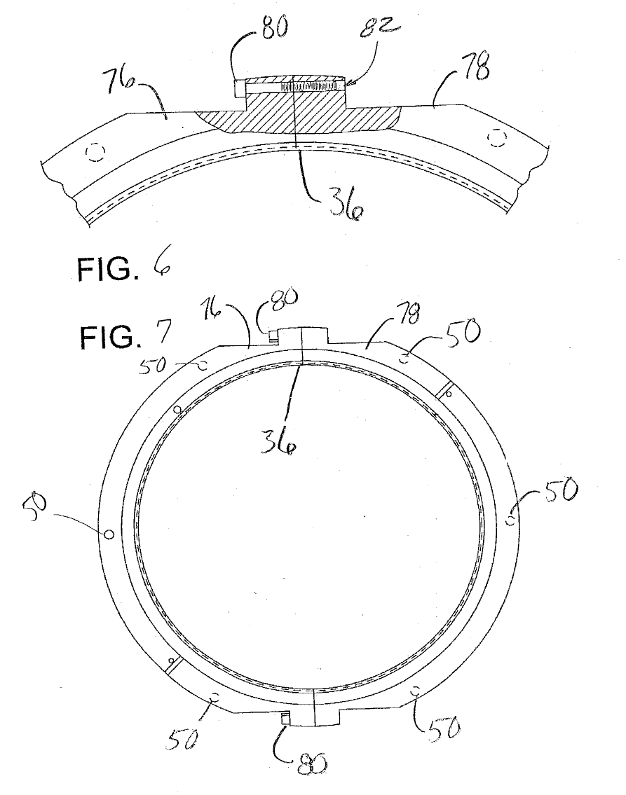

As best seen in FIGS. 4, 6, and 7, housing 36 preferably includes two substantially semicircular halves 76, 78 configured to be joined together around the pipe. Halves 76, 78 may be coupled, for example, by bolts 80 fastened at one or more sets of holes 82, and by dowels 84.

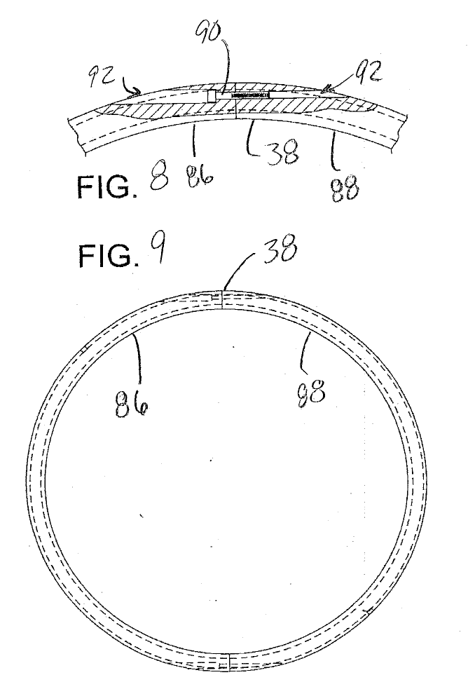

As best seen in FIGS. 4, 8, and 9, seal 38 preferably includes two substantially semicircular halves 86, 88 configured to be joined together around pipe 14. Halves 86, 88 may be coupled, for example, by bolts 90 fastened at one or more sets of holes 92. In FIG. 5 it can be seen that piston 62 may also be formed of two halves with bolts coupling the halves at holes 92.

As best seen in FIGS. 4, 8, and 9, seal 38 defines a substantially annular shape, and it will be understood that piston 62 defines a similar substantially annular shape, as does also housing 36 and chamber 52 (FIGS. 1, 4, 6, and 7). The pressure in chamber 52 can provide for a substantially uniformly distributed pressure about the substantially annular shape to bias the bearing surface against the trunnion opening.

I claim:

1. A sealing assembly for rotatably coupling a rotary drum and a pipe, the drum including a trunnion with a generally circular opening configured to rotate about the pipe, the trunnion opening defining a plane, the pipe including a mounting plate and two or more adjustment screws coupled to the mounting plate, the sealing assembly comprising:
a housing including a chamber configured to contain a pressurizable fluid, the housing configured to be coupled to the adjustment screws of the mounting plate on the pipe; and
a seal including a bearing surface coupled to a driven portion, the bearing surface generally defining a circular shape corresponding to the trunnion opening, the seal coupled to the housing with the driven portion of the seal responsive to fluid pressure in the housing chamber, the seal configured to be biased by the fluid, when pressurized, against the trunnion opening, the bearing surface disposed at an oblique angle with respect to the plane of the trunnion opening.

2. The sealing assembly of claim 1 for use with the trunnion wherein the trunnion includes an outer annular surface that is substantially in the plane defined by the trunnion opening, the outer annular surface adjoining at a corner an inner cylindrical surface of the trunnion, wherein the bearing surface of the seal substantially contacts only the corner of the trunnion opening.

3. The sealing assembly of claim 1 wherein the seal substantially comprises ultra high molecular weight polyethylene.

4. The sealing assembly of claim 1 wherein the pressurizable fluid is air.

5. The sealing assembly of claim 1 wherein the pressurizable fluid is a liquid.

6. The sealing assembly of claim 5 wherein the liquid is water.

7. The sealing assembly of claim 1 further comprising a piston disposed in the chamber of the housing, the piston including an inner surface in contact with the pressurizable-fluid and an outer surface coupled to the seal, the piston biasing the seal against the trunnion opening in response to the pressurizable fluid.

8. The sealing assembly of claim 1 wherein the driven portion of the seal includes a surface in contact with the pressurizable fluid.

9. The sealing assembly of claim 8 further comprising an o-ring disposed between the seal and the chamber of the housing, the o-ring configured to prevent leakage of the pressurizable fluid.

10. The sealing assembly of claim 8 further comprising a plurality of o-rings disposed between the seal and the chamber of the housing, the o-rings configured to prevent leakage of the pressurizable fluid.

11. The sealing assembly of claim 1 for use with the pipe wherein the pipe includes an outer cylindrical surface, wherein the seal is in movable, sealing contact with the outer cylindrical surface of the pipe.

12. The sealing assembly of claim 11 wherein the seal includes an o-ring providing the movable, sealing contact with the outer cylindrical surface of the pipe.

13. The sealing assembly of claim 11 wherein the seal includes a plurality of o-rings providing the movable, sealing contact with the outer cylindrical surface of the pipe.

14. The sealing assembly of claim 11 wherein the housing is configured to provide a clearance between the housing and the outer cylindrical surface of the pipe.

15. The sealing assembly of claim 1 wherein the housing includes two substantially semicircular halves configured to be joined together around the pipe.

16. The sealing assembly of claim 1 wherein the seal is movable by the pressurizable fluid at least about one-half inch.

17. The sealing assembly of claim 1 wherein the pressurizable fluid provides a pressure of at least about 10 psi.

18. The sealing assembly of claim 1 wherein the pressurizable fluid provides a pressure of no more than about 20 psi.

19. The sealing assembly of claim 1 wherein the seal includes two substantially semicircular halves configured to be joined together around the pipe.

20. A sealing assembly for rotatably coupling a rotary drum and a pipe, the drum including a trunnion with a generally circular opening configured to rotate about the pipe, the trunnion opening defining a plane, the pipe including a mounting plate and two or more adjustment screws coupled to the mounting plate, the sealing assembly comprising:
a housing configured to be coupled to the adjustment screws of the mounting plate on the pipe; and
a seal defining a substantially annular shape, the seal including a bearing surface coupled to a driven portion, the bearing surface generally defining a circular shape corresponding to the trunnion opening, the seal coupled to the housing and provided with a substantially uniformly distributed pressure about the substantially annular shape to bias the bearing surface against the trunnion opening.

21. The sealing assembly of claim 20 wherein the bearing surface is disposed at an oblique angle with respect to the plane of the trunnion opening.

22. The sealing assembly of claim 20 for use with the trunnion wherein the trunnion includes an outer annular surface that is substantially in the plane defined by the trunnion opening, the outer annular surface adjoining at a corner an inner cylindrical surface of the trunnion, wherein the bearing surface of the seal substantially contacts only the corner of the trunnion opening.

23. The sealing assembly of claim 20 wherein the seal is movable with respect to the housing at least about one-half inch.

24. The sealing assembly of claim 20 wherein the seal includes two substantially semicircular halves configured to be joined together around the pipe.

25. A sealing assembly for rotatably coupling a rotary drum and a pipe, the drum including a trunnion with a generally circular opening configured to rotate about the pipe, the trunnion opening defining a plane, and wherein the trunnion includes an outer annular surface that is substantially in the plane defined by the trunnion opening, the outer annular surface adjoining at a corner an inner cylindrical surface of the trunnion, the pipe including a mounting plate and two or more adjustment screws coupled to the mounting plate, the sealing assembly comprising:
a housing including a chamber configured to contain a pressurizable fluid, the housing configured to be coupled to the adjustment screws of the mounting plate on the pipe; and
a seal including a bearing surface coupled to a driven portion, the bearing surface generally defining a circular shape corresponding to the trunnion opening, the seal coupled to the housing with the driven portion of the seal responsive to fluid pressure in the housing chamber, the seal configured to be biased by the fluid, when pressurized, against the trunnion opening, wherein the bearing surface of the seal substantially contacts only the corner of the trunnion opening.

26. The sealing assembly of claim 25 wherein the bearing surface is disposed at an oblique angle with respect to the plane of the trunnion opening.

27. The sealing assembly of claim 25 further comprising a piston disposed in the chamber of the housing, the piston including an inner surface in contact with the pressurizable fluid and an outer surface coupled to the seal, the piston biasing the seal against the trunnion opening in response to the pressurizable fluid.

28. The sealing assembly of claim 25 wherein the driven portion of the seal includes a surface in contact with the pressurizable fluid.

29. The sealing assembly of claim 25 for use with the pipe wherein the pipe includes an outer cylindrical surface, wherein the seal is in movable, sealing contact with the outer cylindrical surface of the pipe.

30. The sealing assembly of claim 29 wherein the housing is configured to provide a clearance between the housing and the outer cylindrical surface of the pipe.

31. The sealing assembly of claim 25 wherein the housing includes two substantially semicircular halves configured to be joined together around the pipe.

32. The sealing assembly of claim 25 wherein the seal is movable by the pressurizable fluid at least about one-half inch.

33. The sealing assembly of claim 25 wherein the pressurizable fluid provides a pressure of at least about 10 psi.

34. The sealing assembly of claim 25 wherein the pressurizable fluid provides a pressure of no more than about 20 psi.

35. The sealing assembly of claim 25 wherein the seal includes two substantially semicircular halves configured to be joined together around the pipe.
